(19) United States
(12) Patent Application Publication
(10) Pub. No.: US 2024/0320607 A1
(43) Pub. Date: Sep. 26, 2024

(54) METHOD, APPARATUS AND COMPUTER-READABLE MEDIUM FOR ENHANCED SHIPPING

(71) Applicant: Draying, Inc., Miami, FL (US)

(72) Inventor: Gerardo Bonell Prinetto, Miami, FL (US)

(21) Appl. No.: 18/615,109

(22) Filed: Mar. 25, 2024

Related U.S. Application Data
(60) Provisional application No. 63/454,213, filed on Mar. 23, 2023.

(51) Int. Cl. G06Q 10/0834; G06Q 10/083

(52) U.S. Cl. CPC G06Q 10/08345; G06Q 10/0838

(57) ABSTRACT

Embodiments of the present disclosure provide a method and apparatus. An embodiment of an exemplary method includes determining, by a processor, a time variable associated with obtaining an item from a first location and moving the item from the first location to a second location, and determining, by the processor, a cost variable associated with one of a plurality of vehicles located at a plurality of locations and moving the item from the first location to the second location. The method further includes determining, by the processor, a supply variable associated with an availability of the one of the plurality of vehicles located at the plurality of locations to obtain the item from the first location and moving the item from the first location to the second location, and determining, by the processor, rate associated with each of the plurality of vehicles based on the time variable, the cost variable, and the supply variable.

### BACKGROUND OF THE INVENTION

### Field of the Invention

The present disclosure related to a method, apparatus and computer-readable medium for shipping. The present disclosure relates more particularly to a method, apparatus, and computer-readable medium for enhance shipping and logistics.

### Description of Related Art

The movement of cargo and shipping containers is among the most common ways to move goods around the globe. Conventionally, shipping logistics at shipping ports involve the coordination and management of various activities related to the movement of goods and cargo in and out of the port facility. When a ship arrives at a port, it needs to be directed to the appropriate berth for unloading or loading. Port authorities or harbor master handle this process.

Once a ship is docked, cargo handling operations begin. This involves unloading cargo from incoming vessels and loading cargo onto outgoing vessels. Cranes, forklifts, and other specialized equipment are used for these operations. Depending on the type of cargo, specialized handling procedures may be required to ensure safe and efficient loading and unloading.

After cargo is cleared, the cargo will need to be transported to its final destination. Ports typically have connections to various modes of transportation, including trucks, trains, and sometimes pipelines. Coordination with transportation systems and companies are necessary to ensure timely delivery of cargo to its intended destination.

### BRIEF SUMMARY OF THE INVENTION

In view of the foregoing, it is an objection of the present disclosure to provide a method, apparatus and computer-readable medium for enhanced shipping.

A first embodiment of the present disclosure provides a method. The method includes transmitting, by a user equipment to a processor, a request for data regarding moving an item from a first location to a second location, transmitting, by a processor to a first server, a request for a first historical data associated with moving a plurality of items from at least one of the first location or the second location, and receiving, by the processor from the first server, the first historical data. The method further includes retrieving, by the processor, from a memory associated with the processor, a second historical data associated with moving a plurality of items from at least one of the first location or the second location, determining, by the processor, a time variable associated with obtaining an item from a first location and moving the item from the first location to a second location, and determining, by the processor, a cost variable associated with one of a plurality of vehicles located at a plurality of locations and moving the item from the first location to the second location. The method still further includes determining, by the processor, a supply variable associated with an availability of the one of the plurality of vehicles located at the plurality of locations to obtain the item from the first location and moving the item from the first location to the second location, determining, by the processor, a rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location, and transmitting, by the processor, to the user equipment the rate associated with each of the plurality of vehicles.

A second embodiment of the present disclosure provides an apparatus. The apparatus includes at least one processor and a memory storing computer program instructions executable by the at least one processor, wherein the memory and the computer program instructions and the processor are configured to cause the apparatus to at least receive from a user equipment a request for data regarding moving an item from a first location to a second location, receive from a first server a first historical data associated with moving a plurality of items from at least one of the first location or the second location, and retrieve from a memory associated with the processor, a second historical data associated with moving a plurality of items from at least one of the first location or the second location. The apparatus is further caused to determine a time variable associated with moving an item from a first location to a second location, determine a cost variable associated with one of a plurality of vehicles located at a plurality of locations and moving the item from the first location to the second location, determine a supply variable associated with an availability of the one of the plurality of vehicles located at the plurality of locations to obtain the item from the first location and moving the item from the first location to the second location, determine a rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location, and transmit to the user equipment the rate associated with each of the plurality of vehicles.

A third embodiment of the present disclosure provides a non-transitory computer-readable medium. The non-transitory computer-readable medium tangibly comprising computer program instructions, which, when executed by a processor, causes the processor to at least receive from a user equipment a request for data regarding moving an item from a first location to a second location, receive from a first server a first historical data associated with moving a plurality of items from at least one of the first location or the second location, and retrieve from a memory associated with the processor, a second historical data associated with moving a plurality of items from at least one of the first location or the second location. The processor is further caused to determine a time variable associated with moving an item from a first location to a second location, determine a cost variable associated with one of a plurality of vehicles located at a plurality of locations and moving the item from the first location to the second location, and determine a supply variable associated with an availability of the one of the plurality of vehicles located at the plurality of locations to obtain the item from the first location and moving the item from the first location to the second location. The processor is still further caused to determine a rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location, and transmit to the user equipment the rate associated with each of the plurality of vehicles.

The following will describe embodiments of the present disclosure. However, the present disclosure is not limited to the described embodiments and various modifications of the disclosure are possible without departing from the basic principles described herein

BRIEF DESCRIPTION OF THE SEVERAL VIEWS OF THE DRAWING(S)

Various embodiments are disclosed, by way of example only, with reference to the accompanying schematic drawings below in which corresponding reference symbols indicate corresponding parts. Like drawing numbers on different drawing views identify identical, or functionally similar, structural elements.

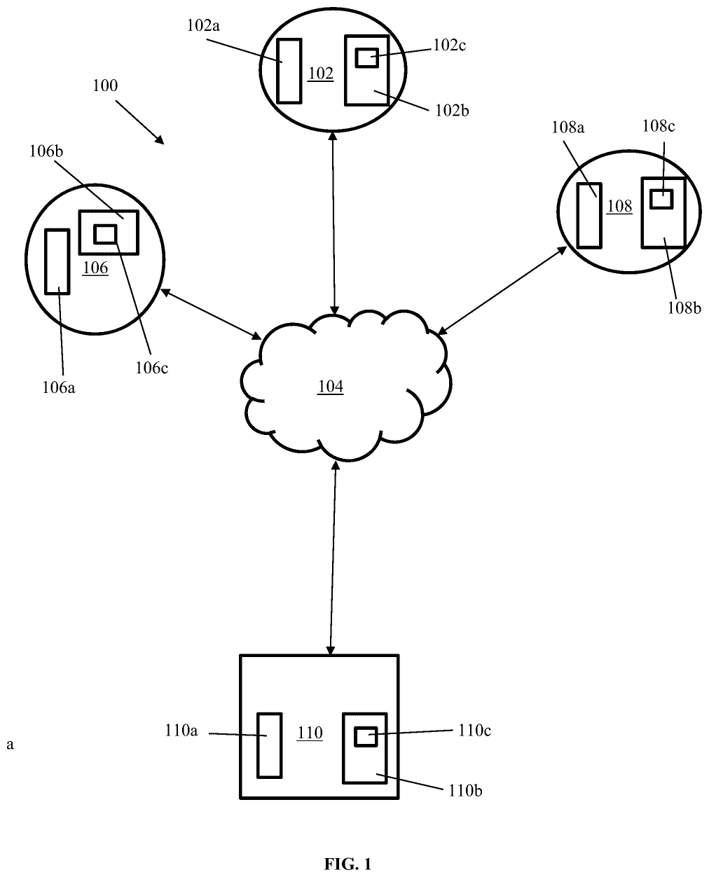

FIG. 1 presents a block diagram of exemplary devices suitable for use in practicing exemplary embodiments of this disclosure.

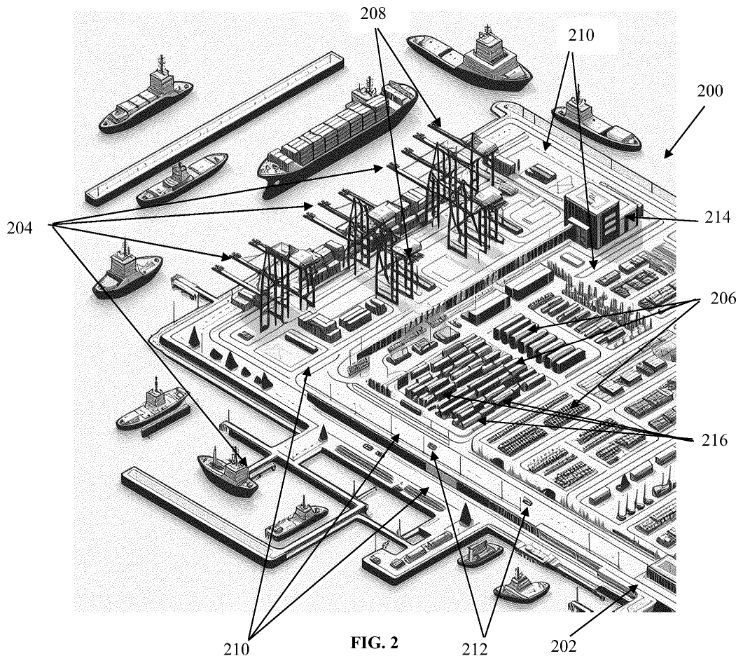

FIG. 2 is an aerial view of an exemplary shipping port suitable for use in practicing exemplary embodiments of this disclosure.

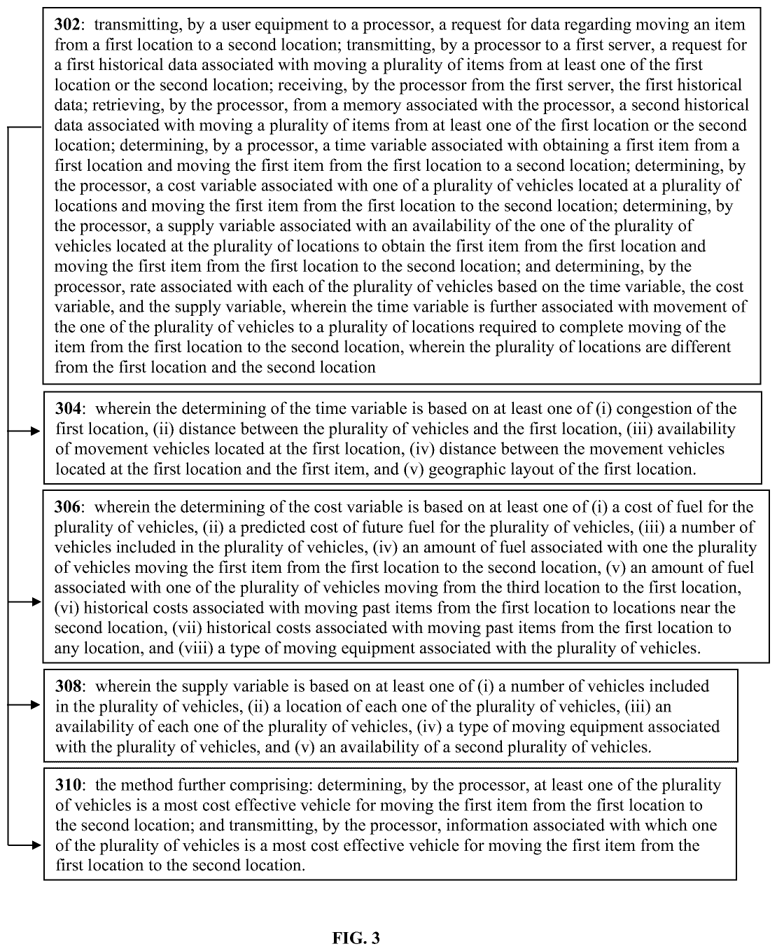

FIG. 3 presents a logic flow diagram suitable of use in performing exemplary embodiments of the present disclosure.

### DETAILED DESCRIPTION OF THE INVENTION

This disclosure is not limited to the particular methodology, materials, and modifications described, and as such, these may vary. Moreover, the terminology used herein is for the purpose of describing particular aspects only and is not intended to limit the scope of the claims. Nor are the claims limited to the disclosed aspects.

Unless defined otherwise, all technical and scientific terms used herein have the same meaning as commonly understood to one of ordinary skill in the art to which this disclosure pertains. Any methods, devices, or materials similar or equivalent to those described herein can be used in the practice or testing of the example embodiments.

As used herein, the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. The term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

The use of “or” in the present application is with respect to a “non-exclusive” arrangement, unless stated otherwise. For example, when stating that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

As used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

Shipping ports across the globe receive millions amounts of goods and other products every day through shipping or ocean containers. Upon receipt of these containers, it is important that these containers be removed from their respective ports such that the goods or products are delivered to their respective end users or customers that are in the supply chain of such goods so that the end products can be brought to market. However, once a container or any type of goods are delivered to a port, it is often the case that many different trucking companies with many different types of trucks and equipment are used to move the containers from the port. This causes inefficiencies in the supply chain and the movement of the containers, goods and/or products, which in turn causes inefficiencies downstream. Embodiments of the present disclosure provide a method, apparatus, and computer-readable medium for enhancing shipping logistics by determining improved shipping information to benefit those having products shipped and those doing the shipping.

There are a number of problems with shipping products from locations that receive a high volume of containers, goods and/or products from many different sources such as a shipping port. First, it is often difficult to determine a competitive and reasonable price for moving such containers, goods and/or products from the shipping port. This is true at least for the reason that many factors are different with each individual container (e.g., the weight of the container or the final location to which the container is to be delivered). Fuel and wage costs contribute to this issue as they are constantly changing. Second, a given container at a port will not remain in the same location within the port. Often times the container will move from a vessel to a yard, then to a warehouse, then be picked up for removal, and then returned to the port after the contents of the container have been removed. Third, it is often difficult to anticipate the number of trips needed to fulfill a given order. Most ports can be congested at times where there are many containers that need to moved within a similar timeframe. At other times, the ports may not be congested wherein there are not many containers or they do not need to be moved at a similar timeframe. The congestion at the port for a particular time can affect where and when a particular container can be moved. Fourth, it is also often difficult to coordinate the drivers that are required to drive the trucks that move the containers. Fifth, not all trucks are equipped with the same moving equipment (e.g., the chasse between different trucks may be different). As such, a given truck may not have the proper equipment to move a given container.

Embodiments of the present disclosure will provide enhanced information for both those doing the shipping and those moving the products that have been shipped. Embodiments provide the ability to provide capacity predictions to ship cargo containers for a given fleet of trucks (also referred to as a plurality of vehicles). Embodiments also provide the ability to provide more accurate predictions of the costs associated with shipping containers both for those doing the shipping and those having items shipped. Embodiments provide the ability to receive recommendations for what a particular shipping company should charge for moving a particular item and/or the margin the shipping company should receive for shipping a given item. Embodiments further provide the ability to receive recommendations for which vehicle is the appropriate vehicle to move a particular container based on the type of vehicle and its equipment.

Referring to FIG. 1, shown is a block diagram of exemplary devices suitable for use in practicing exemplary embodiments of this disclosure. Shown in FIG. 1 is system 100. System 100 includes a first server 102, a network 104, and user equipments (UEs) 106, 108, 110. Embodiments of a user equipment include any electronic device, mobile phone, smartphone, computer, and/or wearable device. Embodiments of UE 106 include a processor 106a, a memory 108b storing computer program instructions 108c, a user interface, a transmitter, and a receiver for transmitting and receiving data. Embodiments of UE 106 are operable to send and receive information from first server 102 and UEs 108 and 110 through network 104. Embodiments of UE 108 include a processor 108a, a memory 108b storing computer program instructions 108c, a user interface, a transmitter, and a receiver for transmitting and receiving data. Embodiments of UE 108 are operable to send and receive information from first server 102, and UEs 106 and 110 through network 104. Embodiments of UE 110 include a processor 110a, a memory 110b storing computer program instructions 110c, a user interface, a transmitter, and a receiver for transmitting and receiving data. Embodiments of UE 110 are operable to send and receive information from first server 102, and UEs 106 and 108 through network 104.

Embodiments of network 104 include the internet or a private network. Embodiments of UE 110 are operable to transmit and receive data from first server 102, UE 106 and UE 108 through network 104. Embodiments of network 104 send and receive communications with any device operable to communicate with the internet and any device connected to the internet. In another embodiment, network 104 is a private network and is only able to communicate with the devices that are connected to the private network.

Exemplary embodiments of first server 102 include a processor, a memory, a transmitter and a receiving for transmitting and receiving data. Embodiments of first server 102 are operable to send and receive information from UEs 106, 108, and 110 through network 104. It should be appreciated that embodiments of first server 102 include one or a plurality of servers each being connected with one another and operable to communicate with UEs 106, 108, and 110 through network 104. It should also be appreciated that embodiments of the present disclosure provide that first server 102 is operable to communicate with numerous electronic devices in addition to UEs 106, 108, and 110.

In practice, and as described in FIG. 1, UE 110 may be an electronic device used by a shipping port (e.g., as shown in FIG. 2) having a plurality of vehicles or trucks that can move cargo containers or products from the shipping port. First server 102 may in this embodiment be a server for customs or another public agency that maintains information related to shipping. First server 102 may also be a server that receives information directly from the shipping port itself. For example, first server 102 may have maintain information regarding (i) the number of cargo containers currently located at the shipping port, (ii) the number cargo containers that have been received by the shipping port in the past few days, weeks, months, or year, (iii) the number of cargo containers that have been removed from the shipping port in the past few days, weeks, months, or year, (iv) the number of trucks that have entered and exited the shipping port with cargo containers, (v) the number empty and the number of full cargo containers, (vi) the layout of the shipping port including the location of the roads, storage yards, cargo moving equipment, (vii) the size and number of docks for vessels or boats, (viii) the schedule of past and future arrivals of vessels or boats, their size and how many cargo containers they contain, and (ix) the schedule of past and future arrivals of cargo containers.

UE 106 and 108 may be associated with entities that require the services of the shipping company that have cargo containers located at the port to be shipped. UE 110 may obtain information from server 102 related to time, costs and supply available to move cargo containers from the shipping port. For example, server 102 may provide UE 110 with any of the information it maintains including (i) port congestion information, (ii) the location of a given cargo container or multiple cargo containers, (iii) fuel prices (e.g., past, present and/or estimated future prices), (iv) availability of moving equipment at the port (e.g., cranes to move the container onto a truck), and/or (v) structure or layout of the port. UE 110 may also obtain location information for where a particular cargo container is to be delivered from UE 106, 108. UE 110 will provide information of the shipper such as (i) a number of vehicles included in the plurality of vehicles, (ii) a location of each one of the plurality of vehicles, (iii) an availability of each one of the plurality of vehicles, and (iv) a type of moving equipment associated with the plurality of vehicles. UE 110 will then use this information to determine a cost variable, time variable, and supply variable. UE 110 is also operable to use this information to determine an appropriate amount it should cost to move a particular cargo container based on the cost variable, time variable, and supply variable, which will be described in more detail below.

Reference is now made to FIG. 2, which illustrates an exemplary shipping port 200. Shown in FIG. 2 is shipping port 200 having a harbor entrance 202, a docking area 204, storage yards 206, cargo handling equipment 208, roads 210, trucks 212, and command center 214. The harbor entrance 202 allows for trucks 212 and other vehicles to enter and exit the shipping port from the surrounding neighborhood. The harbor entrance 202 therefore allows cargo containers 216 to be removed from the storage yards 206 and for the cargo containers 216 to be returned to the storage yards 206. The harbor entrance 202 is connected the storage yards 206, cargo handling equipment 208, trucks 212, and command center 214 by roads 210. Embodiments provide that the harbor entrance 202 are operable to track when a given truck 212 enters or exits the harbor entrance 202. The number of trucks 212 that enter and exit the harbor entrance 202, the cargo that they carry, and whether they are removing cargo containers or delivering cargo containers to the shipping port 200 is maintained at the command center 214 or a first server 102 that may or may not be located at the shipping port 200. It should be appreciated that harbor entrance 202 as depicted in shipping port 200 is a single entrance and exit to the shipping port 200. However, embodiments of harbor entrance 202 include one or more entrances and exits. For instance, a shipping port 200 may include one or more harbor entrances 202 that are both used for entering the shipping port 200 and exiting the shipping port 200. Shipping port 200 may also have one or more harbor entrances 202 that are only used for entering the shipping port 200 or exiting the shipping port 200. In another embodiment, shipping port 200 can have one or more harbor entrances 202 that are used for specific purposes. For instance, one or more harbor entrances 202 may be used exclusively for returning cargo containers, and one or more harbor entrances 202 are used exclusively for removing cargo containers.

The docking area 204 is the area that allows boats and other sea fairing vessels to dock with the shipping port 200 and for the cargo handling equipment 208 to unload the cargo containers 216. The cargo handling equipment 208 can include a plurality of cranes, trucks, forklifts, and other types of tools or vehicles operable to move cargo containers 216.

The trucks 212 are operable to hold cargo containers 216 and to move the cargo containers 216 within the shipping port 200 and locations outside of the shipping port 200 via road 210. The command center 214 can include one of more computers and communication devices for performing embodiments of the present disclosure.

Embodiments provide that the UE 110 will obtain data from the first server 102 associated with a given shipping port 200 and when requested from an exemplary UE 106, 108 associated with an entity that is interested in moving a cargo container either into or out of shipping port 200 will provide information to UE 106, 108 based on a time variable, a cost variable and a supply variable. For example, UE 106, 108 may request information with regards to what they should charge to a particular customer to move a particular cargo container to or from shipping port 200. In another example, UE 106, 108 may request information with regards to what it will cost UE 106, 108 move a particular cargo container to or from shipping port 200. In another example, UE 106, 108 may request information with regards to what UE 106, 108 should be charged by a third party to move a particular cargo container to or from shipping port 200.

Embodiments provide that UE 110 can determine a time variable associated with obtaining a cargo container from a first location and moving the cargo container from the first location to a second location. The time variable is an estimated time it will take a truck to complete the process of performing a particular task, which in this example is obtaining a cargo container from a first location and moving the cargo container from the first location to the second location. The first location may be a location at the shipping port 200, or a location that is outside of the shipping port 200. The second location may be a location at the shipping port 200, or a location that is outside of the shipping port 200, provided that one of the first location and the second location is inside the shipping port 200. For example, the first location may be the shipping port 200 where the cargo container is located after being removed from a vessel or boat, and the second location is the destination of the contents of the cargo container. Embodiments of the time variable are based on and determined by analyzing historical data of moving past cargo containers. The historical data includes at least one of (i) congestion of the first location, (ii) distance between the plurality of vehicles and the first location, (iii) availability of movement vehicles located at the first location, (iv) distance between the movement vehicles located at the first location and the item, and (v) geographic layout of the first location.

Congestion of the first location is determined by calculating the number of containers that have arrived and were unloaded from their respective vessels or boats in the past seven (7) days and the number of containers that were removed from the shipping port in the past seven (7) days. The first server 102 will maintain the number of cargo containers that are located at the shipping port 200 at any given time and the historical data of the number of cargo containers located at the shipping port 200. Congestion also includes the movement of trucks and cargo containers into and out of the shipping port 200 at the harbor entrance 202. This includes the number of trucks and cargo containers into the shipping port 200 and the number of trucks and cargo containers out of the shipping port 200. Congestion is further based on the movement of the trucks 212 at the shipping port 200. Embodiments of the harbor entrance 202 are operable log or keep track of when a particular truck and/or cargo container enters or exits the harbor entrance 202.

For purposes of calculating congestion, the task that a given truck 212 performs is taken into account. For instance, a given truck 212 is operable to perform one of the following tasks. A given truck 212 can (i) remove a cargo container 216 with goods for delivery to a location, (ii) return a cargo container 216 with goods to shipping port 200, (iii) remove an empty cargo container 216 from the shipping port 200, or (iv) return an empty cargo container 216 to the shipping port 200. There are eight combinations of removing and returning cargo containers 216, which include (1) remove a cargo container 216 with goods for delivery to a location, and return a cargo container 216 with goods to shipping port 200, (2) remove a cargo container 216 with goods for delivery to a location, and return an empty cargo container 216 to the shipping port 200, (3) remove an empty cargo container 216 from the shipping port 200, and return a cargo container 216 with goods to shipping port 200, (4) remove an empty cargo container 216 from the shipping port 200, and return an empty cargo container 216 to the shipping port 200, (5) remove a cargo container 216 with goods for delivery to a location, (6) return a cargo container 216 with goods to shipping port 200, (7) remove an empty cargo container 216 from the shipping port 200, and (8) return an empty cargo container 216 to the shipping port 200.

Each one of the tasks performed by a given truck 212 is tracked by or at the harbor entrance 202 and will be used to determine the congestion of the shipping port 200. In other words, embodiments of the present disclosure will use the inbound cargo containers to shipping port 200 and outbound cargo containers from shipping port 200 that occurred in the last seven (7) days and the length of time it took for the trucks 212 to perform each one of the eight combinations of removing and returning cargo containers from shipping port 200 to estimate the time it will take for the trucks 212 to perform each one of the eight combinations of removing and returning cargo containers from shipping port 200. It should be appreciated that embodiments provide that there may be instances in which not all of the eight combinations of truck tasks occurred to in the past seven days. In that instance, UE 110 is operable to estimate the combinations that did not occur based on the combinations that did occur. For instance, in a given seven day period, it is possible that a truck did not remove a cargo container from the shipping port 200 and return an empty cargo container. However, during this same seven-day period a truck may have removed a cargo container from the shipping port 200 and separately a different truck returned an empty cargo container. UE 110 would be operable estimate the combination of a removing a cargo container from the shipping port 200 and returning an empty cargo container based on the individual occurrences.

It should be appreciated that shipping port 200 is merely a representation of a typical shipping port. Each shipping port has it's our configuration, size, layout and boat docking setup, road configuration, local geography, and harbor entrance. Embodiments of the present disclosure provide that the time variable, supply variable, cost variable, and congestion of the specific shipping port will be determined by the variables that are specific to each shipping port. In other words, each shipping port will have its own variables that will be determined based on that shipping port's information (e.g., congestion).

Embodiments of the harbor entrance 202 are operable to keep track of movement of trucks 212 through harbor entrance 202. In other words, embodiments of harbor entrance 202 are operable to monitor when a given truck 212 enters the harbor entrance 202 and when a given truck 212 exits the harbor entrance 202. The movement information of trucks 212 into and out of the harbor entrance 202 will indicate the gate movement.

The distance between the plurality of vehicles or trucks at the shipping port 200 and the first location will be used to determine the time variable and will be able to be determined based on geographic information maintained by UE 110 and/or first server 102. The availability of movement vehicles located at the first location will be provided by first server 102. First server 102 will have information regarding the number of trucks located at the shipping port 200 and whether the trucks are already or plan to be in use for another purpose. The distance between the trucks located at the shipping port and the cargo container that needs to be moved will be determined by a combination of cargo container location information maintained by first server 102 and the location of the trucks also maintained by the first server. The geographic layout of the shipping port will be maintained by the first server 202. The geographic layout can include information such at the location of the docks, the roads, the storage yards where the cargo containers are stacked and stored prior to leaving the shipping port, and the location of the cargo container moving equipment (e.g., cranes and forklifts).

The time variable can also include the amount of time available to move a given cargo container based on a combination of regulations that potentially restrict the number of working hours and the number of working hours associated with a given location. The time variable also includes not considering elements of moving costs that are not impacted directly by the distance needed to perform a given move. These considerations are allocated into the max time variable such that a cost per time unit can be determined. All the costs associated to the moving of an item from a first location to a second location such as fuel, vehicle and equipment use costs, repair costs, and other ancillary costs are combined into a cost per distance unit.

Embodiments of the cost variable are associated with one of a plurality of trucks located at a plurality of locations that will obtain a cargo container from the first location and move the cargo container from the first location to the second location. The cost variable is an estimate of the costs associated with performing a particular task, which in this example is obtain a cargo container from the first location and move the cargo container from the first location to the second location. For example, the plurality of trucks or vehicles may be a fleet of trucks and the plurality of locations are the location of each one of the trucks in the fleet of trucks. The cost variable is based on historical data maintained by UE 110 and collected from public and private data bases. The data can include at least one of (i) a cost of fuel for the plurality of vehicles, (ii) a predicted cost of future fuel for the plurality of vehicles, (iii) a number of vehicles included in the plurality of vehicles, (iv) an amount of fuel associated with one of the plurality of vehicles moving the cargo container from the first location to the second location, (v) an amount of fuel associated with one of the plurality of vehicles moving from the third location to the first location, (vi) historical costs associated with moving past items from the first location to locations near the second location, (vii) historical costs associated with moving past items from the first location to any location, (viii) a type of moving equipment associated with the plurality of vehicles, (ix) distance between the plurality of vehicles and the first location, and (x) distance between the movement vehicles located at the first location and the cargo container.

The cost variable is further associated with indirect (e.g., rent, overhead, equipment leasing costs, business expenses, etc.) and direct costs (e.g., fuel costs, wage costs, etc.) that is historical data maintained by UE 110 and collected from public and private data bases. These indirect and direct costs are the type of costs that a transportation company incurs to operate in order to be able to move an item from a first location to a second location, and the maximum quantity of time that is available to move the item.

Embodiments of the supply variable are associated with an availability of the one of the plurality of trucks or vehicles located at the plurality of locations to obtain the item from the first location and moving the item from the first location to the second location. The supply variable is an estimate of the availability of the trucks or vehicles to perform a particular task. In this example, the supply variable is an estimate of the plurality of trucks or vehicles located at the plurality of locations to obtain the item from the first location and moving the item from the first location to the second location. The supply variable is based on at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles, and (v) an availability of a second plurality of vehicles. The number of vehicles or trucks in the plurality of vehicles is maintained by the first server 102 based on tracking the number of trucks that enter and exit the shipping port 200 through the harbor entrance 202. The availability of the trucks is also tracked and maintained by the first server 102 based on whether the trucks have already entered or exited the harbor entrance 202. The availability of the second plurality of vehicles (e.g., forklifts, cranes, etc.) is based on the whether these vehicles are already in use. This type of information is maintained by the first sever 102.

Once the time variable, the cost variable and the supply variable are determined, embodiments provide they can be used to determine a rate associated with each of the plurality of vehicles based on the time variable, the cost variable, and the supply variable. Embodiments of the rate include a predicted cost of moving the item or cargo container, a proposed fee that the entity doing the shipping should charge for moving the item, or an expected cost for the entity that requires the item to be shipped should expect to pay for having the item shipped.

Embodiments provide that based on the number of plurality of vehicles and the number of items located at the first location, the number of trips required by the plurality of vehicles to move the items in a given day can be determined. Embodiments further provide that based on the number of the plurality of vehicles and the number of items located in a given container, it can be determined the time associated with moving the items from the given container and the number of trips of the plurality of vehicles will be required to move such items. It should be noted that since a given day may have a different number of hours in which the plurality of vehicles are active (e.g., some days may have shorter hours due to holidays), it is important for the owner of the shipper and the shipping company to be able to determine how many trips are required to move the items and over what time frame such items can be moved.

Additionally, embodiments provide that an exemplary system can further include determining which one of the plurality of vehicles is a most cost-effective vehicle for moving the item from the first location to the second location, and transmitting information associated with which one of the plurality of vehicles is a most cost-effective vehicle for moving the item from the first location to the second location.

In practice, a customer associated with UE 106 may have a desire to move a given one or more cargo containers 416 from shipping port 200. UE 106 will send a request through network 104 to UE 110 for information regarding moving a given cargo container from a first location to a second location. In this example, the first location will be the shipping port 200. It should be appreciated that the first location or the second location may be shipping port 200 provided that at least one of them is the shipping port 200. UE 110 will access its historical data for that particular shipping port 200 associated with trucking companies that have trucks that can move cargo containers from the shipping port 200. This can include accessing historical data maintained by server 102 through network 104. UE 110 will determine a time variable, cost variable and supply variable to determine an estimated cost for the trucking company to move the cargo container from the first location to the second location, an estimated amount of profit that the trucking company would receive for moving the cargo container from the first location to the second location, and the projected capacity of the trucking company. This information will be transmitted through network 104 to UE 106 for review by the user of UE 106.

In another embodiment, a trucking company associated with UE 108 that moves cargo containers to and from shipping port 200 may have a desire to actively manage their own capacity to move cargo containers from shipping port 200 over the next 7-days. In other words, the trucking company will want to know whether all of their trucks are allocated to perform pickups and/or deliveries to and from shipping port 200 over the next 7-days, or is the trucking company over or under committed with regards to their plans to move cargo containers to and from shipping port 200. In this embodiment, UE 108 will send a request through network 104 to UE 110 requesting an estimate for the trucking company's supply of trucks over the next 7-days. UE 110 will obtain historical data from its own memory and will send a request to server 102 for historical data associated with the trucking company's supply variable and time variable. Server 102 will transmit the requested information to UE 110 through network 104. UE 110 will then determine a time variable and supply variable associated the trucks associated with UE 108 over the next 7-days to determine whether the trucks associated with the trucking company of UE 108 are performing their deliveries and movements that align or agree with an estimated movement based on the time variable and supply variable. In other words, UE 110 will compare the actual movement and location of the trucks of the trucking company of UE 108 to an estimated movement and location of the trucks of the trucking company of UE 108 that is based on the time variable and supply variable. UE 110 will transmit to UE 108 the estimated movement and location of the trucks of the trucking company of UE 108 and/or a comparison of this to the actual movement and location of the trucks of the trucking company of UE 108.

In yet another embodiment, a trucking company associated with UE 108 (i.e., a company that has a plurality of trucks that are each operable to move cargo containers to and from a shipping port 200) may desire to appropriately schedule the usage of the trucks in their plurality of trucks such that (1) all of the cargo containers that need to be moved within a given time frame are so moved, and (2) all of the trucks are in constant use moving cargo containers that are required to be moved (i.e., there are not trucks that are idle or are not moving cargo containers). UE 108 will send a request through network 104 to UE 110 requesting a proposed schedule of the trucks associated with the trucking company of UE 108. UE 108 will transmit the cargo containers that need to be moved to and from shipping port 200 and the timeframes in which they need to be moved. UE 110 will send a request to server 102 for historical data that it maintains with regards to the trucks associated with the trucking company and server 102 will transmit that information to UE 110. UE 110 will use its own historical data to determine a supply variable and a time variable. UE 110 will use the supply variable and the time variable to determine a proposed schedule for the trucks of the trucking company and will transmit that information to UE 108.

FIG. 3 presents a summary of the above teachings for enhanced shipping logistics. Block 302 presents transmitting, by a user equipment to a processor, a request for data regarding moving an item from a first location to a second location; transmitting, by a processor to a first server, a request for a first historical data associated with moving a plurality of items from at least one of the first location or the second location; receiving, by the processor from the first server, the first historical data; retrieving, by the processor, from a memory associated with the processor, a second historical data associated with moving a plurality of items from at least one of the first location or the second location; determining, by a processor, a time variable associated with obtaining a first item from a first location and moving the first item from the first location to a second location; determining, by the processor, a cost variable associated with one of a plurality of vehicles located at a plurality of locations and moving the first item from the first location to the second location; determining, by the processor, a supply variable associated with an availability of the one of the plurality of vehicles located at the plurality of locations to obtain the first item from the first location and moving the first item from the first location to the second location; and determining, by the processor, rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location. Then block 304 specifies wherein the determining of the time variable is based on at least one of (i) congestion of the first location, (ii) distance between the plurality of vehicles and the first location, (iii) availability of movement vehicles located at the first location, (iv) distance between the movement vehicles located at the first location and the first item, and (v) geographic layout of the first location.

Some of the non-limiting implementations detailed above are also summarized at FIG. 3 following block 304. Block 306 recites wherein the determining of the cost variable is based on at least one of (i) a cost of fuel for the plurality of vehicles, (ii) a predicted cost of future fuel for the plurality of vehicles, (iii) a number of vehicles included in the plurality of vehicles, (iv) an amount of fuel associated with one the plurality of vehicles moving the first item from the first location to the second location, (v) an amount of fuel associated with one of the plurality of vehicles moving from the third location to the first location, (vi) historical costs associated with moving past items from the first location to locations near the second location, (vii) historical costs associated with moving past items from the first location to any location, and (viii) a type of moving equipment associated with the plurality of vehicles. Block 308 relates to wherein the supply variable is based on at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles, and (v) an availability of a second plurality of vehicles. Block 310 states the method further comprising: determining, by the processor, at least one of the plurality of vehicles is a most cost effective vehicle for moving the first item from the first location to the second location; and transmitting, by the processor, information associated with which one of the plurality of vehicles is a most cost effective vehicle for moving the first item from the first location to the second location. Embodiments of the process may continue with block 312 (not show), which specifies determining, by the processor, a capacity for the plurality of vehicles based on at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles; and transmitting, by the processor, the capacity.

The present system therefore provides for a method of determining a time variable, a cost variable and a supply variable for efficiently allocating resources to move an item from one location to another location. FIG. 3 may be considered to illustrate the operation of a method, a result of execution of computer program instructions stored in a computer-readable medium. The logic diagram of FIG. 3 may also be considered a specific manner in which components of a device are configured to cause that device to operate, whether such device is a mobile phone, cell phone, smart phone, laptop, tablet, desktop or other electronic device, or one or more components thereof. The various blocks shown in FIG. 3 may also be considered as a plurality of coupled logic circuit elements constructed to carry out the associated function(s), or specific

This disclosure has been described in detail with particular reference to an embodiment, but it will be understood that variations and modifications can be affected within the spirit and scope of the disclosure. The presently disclosed embodiments are therefore considered in all respects to be illustrative and not restrictive. The scope of the disclosure is indicated by the appended claims, and all changes that come within the meaning and range of equivalents thereof are intended to be embraced therein.

1. A method comprising:
transmitting, by a user equipment to a processor, a request for data regarding moving an item from a first location to a second location;
transmitting, by a processor to a first server, a request for a first historical data associated with moving a plurality of items from at least one of the first location or the second location;
receiving, by the processor from the first server, the first historical data;
retrieving, by the processor, from a memory associated with the processor, a second historical data associated with moving a plurality of items from at least one of the first location or the second location;
determining, by the processor, a time variable associated with obtaining an item from a first location and moving the item from the first location to a second location;
determining, by the processor, a cost variable associated with one of a plurality of vehicles located at a plurality of locations and moving the item from the first location to the second location;
determining, by the processor, a supply variable associated with an availability of the one of the plurality of vehicles located at the plurality of locations to obtain the item from the first location and moving the item from the first location to the second location; and
determining, by the processor, a rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location; and
transmitting, by the processor, to the user equipment the rate associated with each of the plurality of vehicles.

2. The method of claim 1, wherein the determining of the time variable is based on at least one of (i) congestion of the first location, (ii) distance between the plurality of vehicles and the first location, (iii) availability of movement vehicles located at the first location, (iv) distance between the movement vehicles located at the first location and the item, and (v) geographic layout of the first location.

3. The method of claim 1, the method further comprising the processor obtaining from a plurality of servers at least one of (i) congestion of the first location, (ii) distance between the plurality of vehicles and the first location, (iii) availability of movement vehicles located at the first location, (iv) distance between the movement vehicles located at the first location and the item, and (v) geographic layout of the first location.

4. The method of claim 1, wherein the determining of the cost variable is based on at least one of (i) a cost of fuel for the plurality of vehicles, (ii) a predicted cost of future fuel for the plurality of vehicles, (iii) a number of vehicles included in the plurality of vehicles, (iv) an amount of fuel associated with one the plurality of vehicles moving the item from the first location to the second location, (v) an amount of fuel associated with one of the plurality of vehicles moving from the third location to the first location, (vi) historical costs associated with moving past items from the first location to locations near the second location, (vii) historical costs associated with moving past items from the first location to any location, and (viii) a type of moving equipment associated with the plurality of vehicles.

5. The method of claim 1, the method further comprising the processor obtaining from a first server different from the plurality of servers at least one of (i) a cost of fuel for the plurality of vehicles, (ii) a predicted cost of future fuel for the plurality of vehicles, (iii) a number of vehicles included in the plurality of vehicles, (iv) an amount of fuel associated with one the plurality of vehicles moving the item from the first location to the second location, (v) an amount of fuel associated with one of the plurality of vehicles moving from the third location to the first location, (vi) historical costs associated with moving past items from the first location to locations near the second location, and (vii) historical costs associated with moving past items from the first location to any location.

6. The method of claim 1, wherein the supply variable is based on at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles, and (v) an availability of a second plurality of vehicles.

7. The method of claim 1, the method further comprising the processor obtaining from a first server different from the plurality of servers at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles, and (v) an availability of a second plurality of vehicles.

8. The method of claim 1, the method further comprising:
determining, by the processor, at least one of the plurality of vehicles is a most cost-effective vehicle for moving the item from the first location to the second location; and
transmitting, by the processor, information associated with which one of the plurality of vehicles is a most cost-effective vehicle for moving the item from the first location to the second location.

9. The method of claim 1, the method further comprising:
determining, by the processor, a capacity for the plurality of vehicles based on at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles; and
transmitting, by the processor, the capacity.

10. An apparatus comprising at least one processor and a memory storing computer program instructions executable by the at least one processor, wherein the memory and the computer program instructions and the processor are configured to cause the apparatus to at least:
receive from a user equipment a request for data regarding moving an item from a first location to a second location;
receive from a first server a first historical data associated with moving a plurality of items from at least one of the first location or the second location;
retrieve from a memory associated with the processor, a second historical data associated with moving a plurality of items from at least one of the first location or the second location;
determine a time variable associated with moving an item from a first location to a second location;
determine a cost variable associated with one of a plurality of vehicles located at a plurality of locations and moving the item from the first location to the second location;
determine a supply variable associated with an availability of the one of the plurality of vehicles located at the plurality of locations to obtain the item from the first location and moving the item from the first location to the second location;
determine a rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location; and
transmit to the user equipment the rate associated with each of the plurality of vehicles.

11. The apparatus of claim 10, wherein the determining of the time variable is based on at least one of (i) congestion of the first location, (ii) distance between the plurality of vehicles and the first location, (iii) availability of movement vehicles located at the first location, (iv) distance between the movement vehicles located at the first location and the item, and (v) geographic layout of the first location.

12. The apparatus of claim 10, wherein the processor is further configured to cause the apparatus to obtain from a plurality of servers at least one of (i) congestion of the first location, (ii) distance between the plurality of vehicles and the first location, (iii) availability of movement vehicles located at the first location, (iv) distance between the movement vehicles located at the first location and the item, and (v) geographic layout of the first location.

13. The apparatus of claim 10, wherein the determining of the cost variable is based on at least one of (i) a cost of fuel for the plurality of vehicles, (ii) a predicted cost of future fuel for the plurality of vehicles, (iii) a number of vehicles included in the plurality of vehicles, (iv) an amount of fuel associated with one the plurality of vehicles moving the item from the first location to the second location, (v) an amount of fuel associated with one of the plurality of vehicles moving from the third location to the first location, (vi) historical costs associated with moving past items from the first location to locations near the second location, (vii) historical costs associated with moving past items from the first location to any location, and (viii) a type of moving equipment associated with the plurality of vehicles.

14. The apparatus of claim 10, wherein the processor is further configured to cause the apparatus to obtain from a first server different from the plurality of servers at least one of (i) a cost of fuel for the plurality of vehicles, (ii) a predicted cost of future fuel for the plurality of vehicles, (iii) a number of vehicles included in the plurality of vehicles, (iv) an amount of fuel associated with one the plurality of vehicles moving the item from the first location to the second location, (v) an amount of fuel associated with one of the plurality of vehicles moving from the third location to the first location, (vi) historical costs associated with moving past items from the first location to locations near the second location, and (vii) historical costs associated with moving past items from the first location to any location.

15. The apparatus of claim 10, wherein the supply variable is based on at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles, and (v) an availability of a second plurality of vehicles.

16. The apparatus of claim 10, wherein the processor is further configured to cause the apparatus to obtain from a first server different from the plurality of servers at least one of (i) a number of vehicles included in the plurality of vehicles, (ii) a location of each one of the plurality of vehicles, (iii) an availability of each one of the plurality of vehicles, (iv) a type of moving equipment associated with the plurality of vehicles, and (v) an availability of a second plurality of vehicles.

17. The apparatus of claim 10, wherein the processor is further configured to cause the apparatus to:
determine at least one of the plurality of vehicles is a most cost-effective vehicle for moving the item from the first location to the second location; and
transmit information associated with which one of the plurality of vehicles is a most cost-effective vehicle for moving the item from the first location to the second location.

18. A non-transitory computer-readable medium comprising computer program instructions, which, when executed by a processor, causes the processor to at least:
receive from a user equipment a request for data regarding moving an item from a first location to a second location;
receive from a first server a first historical data associated with moving a plurality of items from at least one of the first location or the second location;
retrieve from a memory associated with the processor, a second historical data associated with moving a plurality of items from at least one of the first location or the second location;
determine a time variable associated with moving an item from a first location to a second location;
determine a cost variable associated with one of a plurality of vehicles located at a plurality of locations and moving the item from the first location to the second location;
determine a supply variable associated with an availability of the one of the plurality of vehicles located at the plurality of locations to obtain the item from the first location and moving the item from the first location to the second location;
determine a rate associated with each of the plurality of vehicles based on the time variable, the cost variable, and the supply variable, wherein the time variable is further associated with movement of the one of the plurality of vehicles to a plurality of locations required to complete moving of the item from the first location to the second location, wherein the plurality of locations are different from the first location and the second location; and
transmit to the user equipment the rate associated with each of the plurality of vehicles.

19. The non-transitory computer-readable medium of claim 18, wherein the determining of the time variable is based on at least one of (i) congestion of the first location, (ii) distance between the plurality of vehicles and the first location, (iii) availability of movement vehicles located at the first location, (iv) distance between the movement vehicles located at the first location and the item, and (v) geographic layout of the first location.

20. The non-transitory computer-readable medium of claim 18, wherein the determining of the cost variable is based on at least one of (i) a cost of fuel for the plurality of vehicles, (ii) a predicted cost of future fuel for the plurality of vehicles, (iii) a number of vehicles included in the plurality of vehicles, (iv) an amount of fuel associated with one the plurality of vehicles moving the item from the first location to the second location, (v) an amount of fuel associated with one of the plurality of vehicles moving from the third location to the first location, (vi) historical costs associated with moving past items from the first location to locations near the second location, (vii) historical costs associated with moving past items from the first location to any location, and (viii) a type of moving equipment associated with the plurality of vehicles.
